(19) United States
(12) Patent Application Publication
(10) Pub. No.: US 2026/0181127 A1
(43) Pub. Date: Jun. 25, 2026

(54) PERSONAL IMMERSIVE DISPLAY APPARATUS AND DRIVING METHOD THEREOF

(71) Applicant: LG Display Co., Ltd., Seoul (KR)

(72) Inventor: Chang Mo YANG, Paju-si (KR)

(73) Assignee: LG Display Co., Ltd., Seoul (KR)

(21) Appl. No.: 19/338,995

(22) Filed: Sep. 24, 2025

(30) Foreign Application Priority Data
Dec. 20, 2024 (KR) 10-2024-0193080

(51) Int. Cl. H04N 13/344; G02B 27/00; G02B 27/01; G09G 3/3208; H04N 13/383; H04N 13/398

(52) U.S. Cl. CPC H04N 13/344; G02B 27/0093; G02B 27/0172; G09G 3/3208; H04N 13/383; H04N 13/398; G02B 2027/0138; G09G 2320/0653; G09G 2330/021

(57) ABSTRACT

A personal immersive display apparatus includes a left-eye display configured to display a left-eye image and a right-eye display configured to display a right-eye image. An entire image simultaneously implemented through the left-eye and right-eye displays is divided into an overlap image region where the left-eye image and the right-eye image overlap each other and a non-overlap image region of the left-eye image or the right-eye image disposed at both sides of the overlap image region, the overlap image region includes a two-dimensional (2D) region displaying a left-eye overlap 2D image and a right-eye overlap 2D image, and a maximum luminance of one of the left-eye overlap 2D image and the right-eye overlap 2D image is lower than a maximum luminance of the other of the left-eye overlap 2D image and the right-eye overlap 2D image.

### CROSS-REFERENCE TO RELATED APPLICATIONS

This application claims priority to Korean Patent Application No. 10-2024-0193080, filed in the Republic of Korea on Dec. 20, 2024, which is hereby expressly incorporated by reference as if fully set forth herein.

### BACKGROUND

### Field of the Invention

The present disclosure relates to a personal immersive display apparatus and a driving method thereof.

### Discussion of the Related Art

Virtual reality (VR) technology is applied to the fields of national defense, architecture, tour, movies, multimedia, and games. VR denotes a specific environment and situation which are felt and experienced by users similar to a real environment by using stereoscopic image technology. To maximize the immersion of VR, VR technology is applied to personal immersive display apparatuses.

Personal immersive display apparatuses contribute to enhance the daily life of users and work efficiency in association with wearable technology. Such personal immersive display apparatuses need low power driving for portable convenience.

### SUMMARY OF THE DISCLOSURE

Therefore, the present disclosure provides a personal immersive display apparatus and a driving method thereof, which can decrease power consumption.

An object of the present disclosure is to provide a personal immersive display apparatus and a method driving the same, which address the limitations and disadvantages associated with the related art.

To achieve these objects and other advantages and in accordance with the purpose of the disclosure, as embodied and broadly described herein, a personal immersive display apparatus includes a left-eye display configured to display a left-eye image and a right-eye display configured to display a right-eye image, wherein an entire image simultaneously implemented through the left-eye and right-eye displays is divided into an overlap image region where the left-eye image and the right-eye image overlap each other and a non-overlap image region of the left-eye image or the right-eye image disposed at one side of the overlap image region. Further, the overlap image region includes a two-dimensional (2D) region for displaying a left-eye overlap 2D image and a right-eye overlap 2D image, and a maximum luminance of one of the left-eye overlap 2D image and the right-eye overlap 2D image is lower than a maximum luminance of the other of the left-eye overlap 2D image and the right-eye overlap 2D image.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a diagram illustrating a personal immersive display apparatus according to an embodiment of the present disclosure;

FIG. 2 is a diagram illustrating first and second display panels in a display module of the personal immersive display apparatus illustrated in FIG. 1;

FIG. 3 is a diagram illustrating a distance between the first and second display panels illustrated in FIG. 2;

FIG. 4 is a diagram illustrating an entire image simultaneously recognized with both eyes of a user according to an example of the present disclosure;

FIGS. 5A and 5B are diagrams for describing a method where a user recognizes an entire image according to an example of the present disclosure;

FIG. 6 is a diagram illustrating a driving example which changes a power saving mode, based on a type of virtual reality (VR) input image according to an example of the present disclosure;

FIG. 7 is a diagram illustrating a method of determining whether a VR input image is a two-dimensional (2D) image type or a three-dimensional (3D) image type according to an example of the present disclosure;

FIG. 8 is a diagram illustrating a method of implementing a first power saving mode corresponding to a 2D image type according to an example of the present disclosure;

FIGS. 9 and 10 are diagrams illustrating an example which implements one of a left-eye display and a right-eye display as a power saving display and implements the other of the left-eye and right-eye displays display as a non-power saving display, in a first power saving mode according to an example of the present disclosure;

FIGS. 11A and 11B are diagrams illustrating a luminance variation form in a boundary processing region, contacting a nonoverlap image region, of an overlap image region according to an example of the present disclosure;

FIGS. 12A and 12B are diagrams illustrating an example where a width of a boundary processing region is differently set based on a luminance difference between an overlap image region and a nonoverlap image region according to an example of the present disclosure;

FIG. 13 is a diagram illustrating a method of implementing a second power saving mode corresponding to a combination image type of 2D and 3D images according to an example of the present disclosure;

FIG. 14 is a diagram illustrating a method of selecting a region of interest (ROI) based on eye tracking according to an example of the present disclosure;

FIGS. 15 and 16 are diagrams illustrating an example where one of left-eye and right-eye displays is implemented as a power saving display, and the other of the left-eye and right-eye displays is implemented as a non-power saving display, in a second power saving mode according to an example of the present disclosure;

FIGS. 17A and 17B are diagrams illustrating an example where a width of an auxiliary boundary processing region is differently set based on a moving speed of an ROI according to an example of the present disclosure;

FIG. 18 is a diagram illustrating an example where a power saving display is changed from a left-eye display to a right-eye display or is changed to be opposite thereto, at a time at which an average picture level (APL) between continuous frames is rapidly changed according to an example of the present disclosure; and

FIG. 19 is a diagram illustrating an example which sets a display, where a time taken in using as a power saving display is relatively shorter, to a power saving display among left-eye and right-eye displays when a system power is applied according to an example of the present disclosure.

### DETAILED DESCRIPTION OF THE EMBODIMENTS

Hereinafter, the present disclosure will be described more fully with reference to the accompanying drawings, in which example embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Furthermore, the present disclosure is only defined by scopes of claims.

The shapes, sizes, ratios, angles, numbers and the like disclosed in the drawings for description of various embodiments of the present disclosure to describe embodiments of the present disclosure are merely examples and the present disclosure is not limited thereto. Like reference numerals refer to like elements throughout. Throughout this specification, the same elements are denoted by the same reference numerals. As used herein, the terms “comprise”, “having,” “including” and the like suggest that other parts can be added unless the term “only” is used. As used herein, the singular forms “a”, “an”, and “the” are intended to include the plural forms as well, unless context clearly indicates otherwise.

Elements in various embodiments of the present disclosure are to be interpreted as including margins of error even without explicit statements.

In describing a position relationship, for example, when a position relation between two parts is described as “on”, “over”, “under”, and “next”, one or more other parts can be disposed between the two parts unless “just” or “direct” is used. Further, the term “can” fully encompasses all the meanings and coverages of the term “may” and vice versa.

Hereinafter, embodiments of the present disclosure will be described in detail with reference to the accompanying drawings. All the components of each display apparatus/device according to all embodiments of the present disclosure are operatively coupled and configured. In the following description, when the detailed description of the relevant known function or configuration is determined to unnecessarily obscure the important point of the present disclosure, the detailed description will be omitted or may be briefly provided.

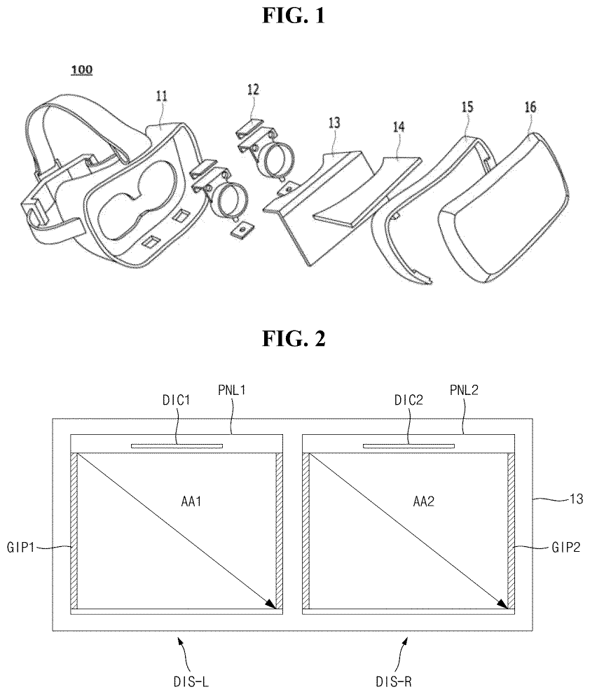

FIG. 1 is a diagram illustrating a personal immersive display apparatus according to an embodiment of the present disclosure.

Referring to FIG. 1, a display apparatus 100 according to an embodiment of the present disclosure can be a personal immersive display apparatus. The personal immersive display apparatus 100 can be an apparatus to which functions such as augmented reality (AR), virtual reality (VR), and extended reality (XR) are applied and can include all electronic devices which are attached on a human body and perform a computing function. Head mounted displays (HMDs), face mounted displays (FMDs), and eye glasses-type displays (EGDs) can be representative apparatuses to which a personal immersive display apparatus is applied.

Personal immersive display apparatuses can require lightening technology and low power technology, where there is no inconvenience despite an apparatus being worn for a long time.

A personal immersive display apparatus according to an embodiment of the present disclosure, for example, can be referred to as an HMD. The personal immersive display apparatus 100, as in FIG. 1, can include a lens module 12, a display module 13, a main board 14, a head gear 11, a side frame 15, and a front cover 16.

The display module 13 can include a display panel driving circuit for driving each of two display panels and can display an input image received from the main board 14. The display panels can be divided into a first display panel which is seen with a left eye of a user and a second display panel which is seen with a right eye of the user. The display module 13 can display image data, input from the main board 14, on the display panels. The image data can be two-dimensional (2D)/three-dimensional (3D) image data implementing a video image of VR or AR. The display module 13 can display various information, input from the main board 14, in the form of texts or signs.

The lens module 12 can include a super wide angle lens (i.e., a pair of fisheye lenses) for widening a field of view of each of left and right eyes of a user. The pair of fisheye lenses can include a left-eye lens disposed ahead of the first display panel and a right-eye lens disposed ahead of the second display panel.

A camera for photographing an eye focus of a user can be disposed in the lens module 12. The camera can photograph both eyes of the user and can transmit photographed information to a processor.

The main board 14 can include the processor which executes VR software and supplies a left-eye image and a right-eye image to the display module 13.

The main board 14 can further include a sensor module and an interface module connected to an external device. The interface module can be connected to the external device through an interface such as a universal serial bus (USB) or a high definition multimedia interface (HDMI). The sensor module can include various sensors such as a gyro sensor and an acceleration sensor.

In response to an output signal of the sensor module, the processor of the main board 14 can correct left-eye and right-eye image data and can transfer left-eye and right-eye image data of an input image, received through the interface module, to the display module 13. The processor can generate a left-eye image and a right-eye image suitable for a resolution of the display panel to transfer the left-eye image and the right-eye image to the display module 13, based on a depth information analysis result of a 2D image. The processor can transfer to the display module 13, a left-eye timing control signal for controlling a display timing of the left-eye image and a right-eye timing control signal for controlling a display timing of the right-eye image.

The head gear 11 can include a back cover which exposes the fisheye lenses and a band connected to the back cover. The back cover of the head gear 11, the side frame 15, and the front cover 16 can be assembled to secure an internal space where the elements of the personal immersive display apparatus are disposed and can protect the elements. The elements can include the lens module 12, the display module 13, and the main board 14. The band can be connected to the back cover. A user can wear the personal immersive display apparatus as a band on its head. When the user wears the personal immersive display apparatus on its head, the user can see different display panels with a left eye and a right eye through the fisheye lenses.

The side frame 15 can be fixed between the head gear 11 and the front cover 16 and can secure a gap of an internal space where the lens module 12, the display module 13, and the main board 14 are disposed. The front cover 16 can be disposed on a front surface of the personal immersive display apparatus.

The personal immersive display apparatus is not limited to an HMD structure illustrated in FIG. 1 and can be designed as an EGD of a glasses structure.

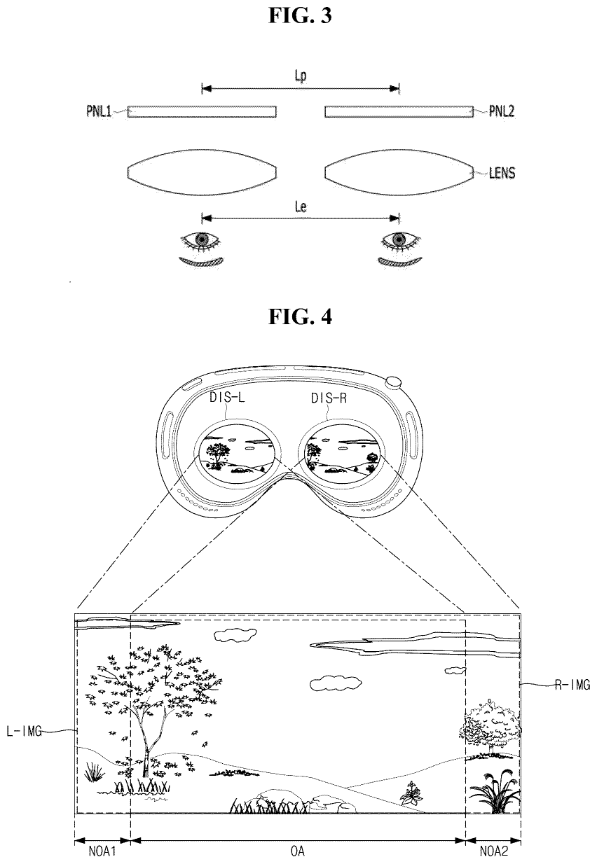

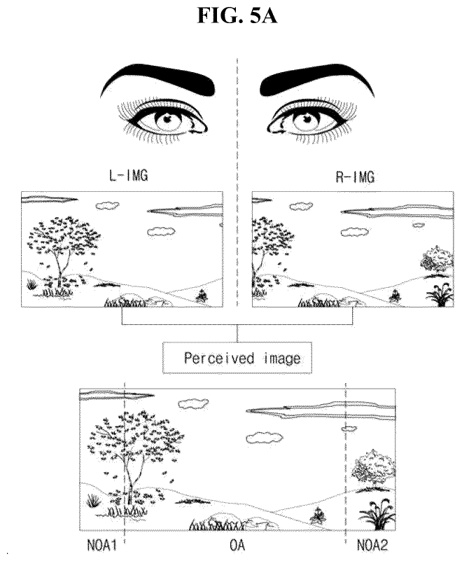

FIG. 2 is a diagram illustrating first and second display panels in the display module illustrated in FIG. 1. FIG. 3 is a diagram illustrating a distance between the first and second display panels illustrated in FIG. 2.

Each of first and second display panels PNL1 and PNL2 can be implemented as an organic light emitting diode (hereinafter referred to as an OLED) display panel which is fast in response time and good in color reproduction characteristic and has a wide viewing angle. In an EGD, each of the first and second display panels PNL1 and PNL2 can be implemented as a transparent OLED display panel.

Referring to FIGS. 2 and 3, a left-eye display panel DIS-L for displaying a left-eye image and a right-eye display panel DIS-R for displaying a right-eye image can be included in the display module 13.

The left-eye display DIS-L can include the first display panel PNL1, a drive integrated circuit (DIC1), and a gate in panel (GIP1). The right-eye display panel DIS-R can include the second display panel PNL2, a drive integrated circuit (DIC2), and a gate in panel (GIP2).

The first and second display panels PNL1 and PNL2 can be separately manufactured and can be disposed apart from each other in the display module 13.

The DIC1 and the DIC2 can each be an integrated circuit (IC) chip with a timing controller and a data driver integrated therein. The GIP1 and the GIP2 can each correspond to a gate driver and can each output a scan signal and an emission (EM) signal. The GIP1 and the GIP2 can be integrated into the same substrate along with a pixel array.

A distance Lp between a pixel array center of the first display panel PNL1 and a pixel array center of the second display panel PNL2 can be set to “Le±α”. A distance Le between both eyes of a user can be a distance between a left-eye pupil and a right-eye pupil and can be about 6.5 cm (=65 mm), and in this case, there can be a slight difference, based on races. In this case, α can be a design margin based on a process deviation and a display panel driving circuit disposed between the first display panel PNL1 and the second display panel PNL2 and can be set to 10% of Le.

A pixel array AA of each of the first and second display panels PNL1 and PNL2 can have a screen ratio of a landscape type where a length in a horizontal direction x is longer than a length in a vertical direction y, based on a vertical viewing angle and a horizontal viewing angle. In the personal immersive display apparatus, when a horizontal viewing angle is greater than a vertical viewing angle, an effect of improving a viewing angle can be large. To maximize a horizontal viewing angle and provide a better sense of three dimensions, each of the first and second display panels PNL1 and PNL2 can be implemented as an OLED display panel of a landscape type.

In the personal immersive display apparatus, a left-eye pupil of a user can match a center of a first pixel array, and a right-eye pupil of the user can match a center of a second pixel array. When pixel arrays of the first and second display panels PNL1 and PNL2 are separated from each other and a distance between centers of the pixel arrays matches the left eye and the right eye of the user, a viewing angle can be wide, and an effect of improving a viewing angle can be large.

The pixel arrays AA can be separated from each other on one substrate so that a first pixel array AA displaying a left-eye image is separated from a second pixel array AA displaying a right-eye image. Here, pixel arrays being separated from each other can denote that data lines, gate lines (or scan lines), and pixels are separated from each other. Because the first and second pixel arrays AA are separated from each other and are driven based on the same driving signal system, the first and second pixel arrays AA can share at least a portion of the display panel driving circuit.

When two pixel arrays AA are disposed apart from each other on one substrate, an effect of improving a sense of three dimensions and various effects can be provided. For example, an arrangement design of pixel arrays can be more freely implemented, and the pixel arrays AA can be disposed at an optimal viewing angle ratio of 1:1 with respect to a left eye and a right eye of a user, thereby maximizing a sense of three dimensions.

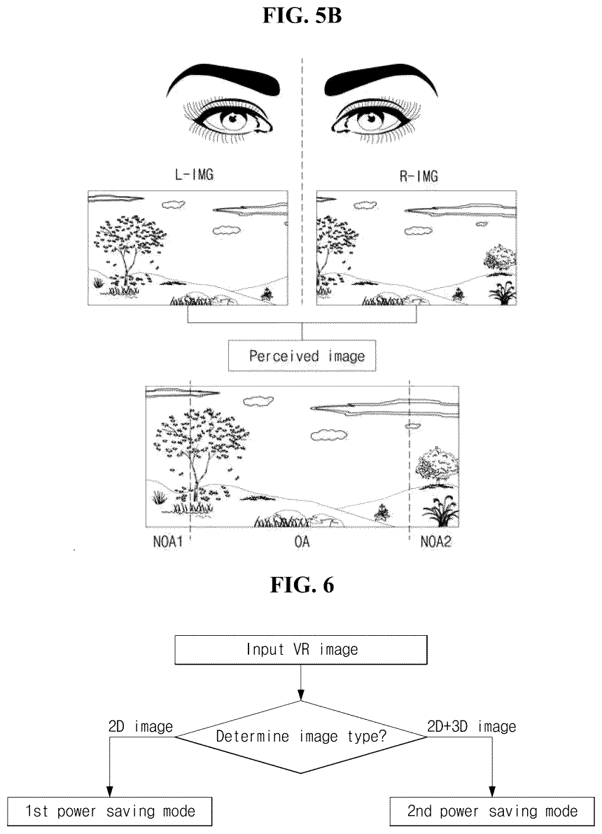

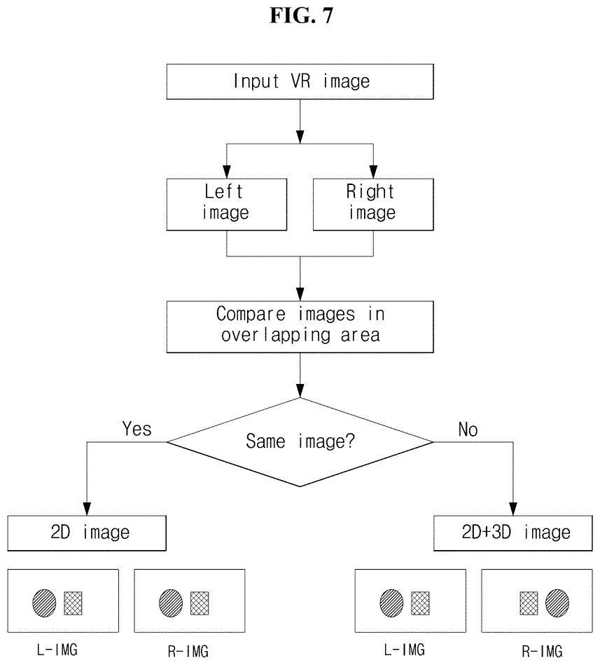

FIG. 4 is a diagram illustrating an entire image simultaneously recognized with both eyes of a user. FIGS. 5A and 5B are diagrams for describing a method where a user recognizes an entire image.

Referring to FIG. 4, an entire image recognized through both eyes can be divided into an overlap image region OA where a left-eye image L-IMG and a right-eye image R-IMG overlap each other, a first non-overlap image region NOA1 disposed at a left side of the overlap image region OA, and a second non-overlap image region NOA2 disposed at a right side of the overlap image region OA.

The left-eye image L-IMG and the right-eye image R-IMG can be displayed to overlap each other in the overlap image region OA. Hereinafter, the left-eye image L-IMG disposed on the overlap image region OA can be referred to as a “left-eye overlap image”, and the right-eye image R-IMG disposed on the overlap image region OA can be referred to as a “right-eye overlap image”.

The left-eye image L-IMG can be individually disposed on the first non-overlap image region NOA1, and the right-eye image R-IMG can be individually disposed on the second non-overlap image region NOA2.

When the left-eye image L-IMG and the right-eye image R-IMG differing in maximum luminance overlap each other in the overlap image region OA, brains of persons can excellently recognize an overlap image having relatively higher luminance among a left-eye overlap image and a right-eye overlap image instead of an average luminance of the left-eye overlap image and the right-eye overlap image and may not well recognize an overlap image having relatively low luminance.

For example, as in FIG. 5A, when the left-eye image L-IMG and the right-eye image R-IMG where a maximum luminance difference is relatively small overlap each other in the overlap image region OA, an overlap image having relatively higher luminance among the left-eye overlap image and the right-eye overlap image can be excellently recognized.

Moreover, as in FIG. 5B, when the left-eye image L-IMG and the right-eye image R-IMG where a maximum luminance difference is relatively large overlap each other in the overlap image region OA, the left-eye overlap image having relatively higher luminance can be excellently recognized.

As a result, even when a maximum luminance of one of a left-eye overlap image and a right-eye overlap image is set to be lower than original 100% so as to reduce power consumption, the visual inconvenience of a user may not be large. This can be because a user preferentially perceive an overlap image having maximum luminance which is relatively higher, in an overlap image region OA.

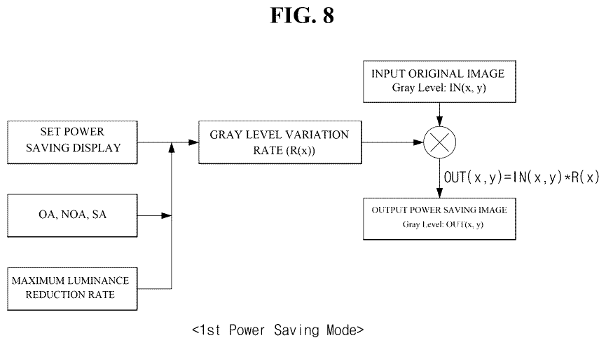

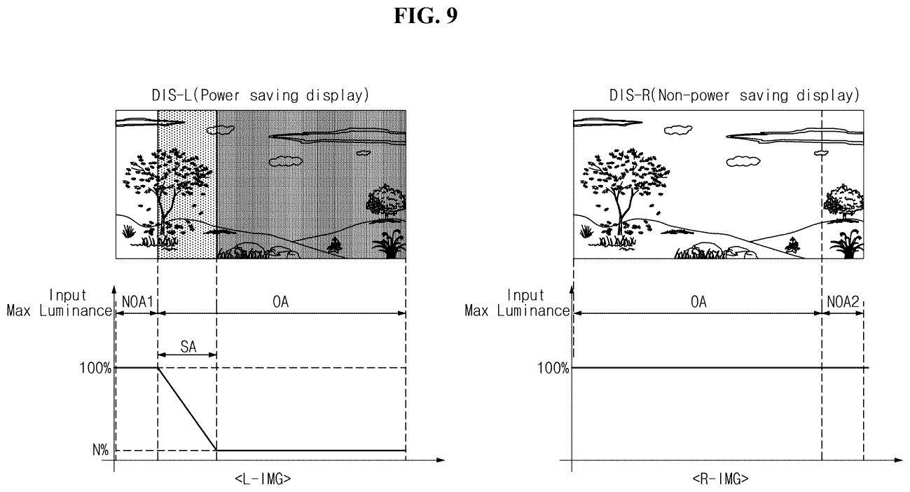

FIG. 6 is a diagram illustrating a driving example which changes a power saving mode, based on a type of VR input image. FIG. 7 is a diagram illustrating a method of distinguishing whether a VR input image is a 2D image type or a mixed image type of 2D and 3D images.

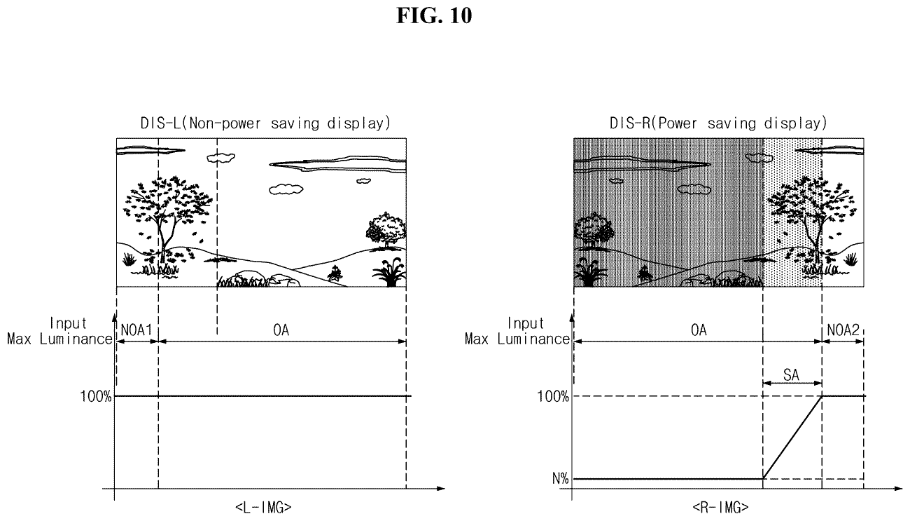

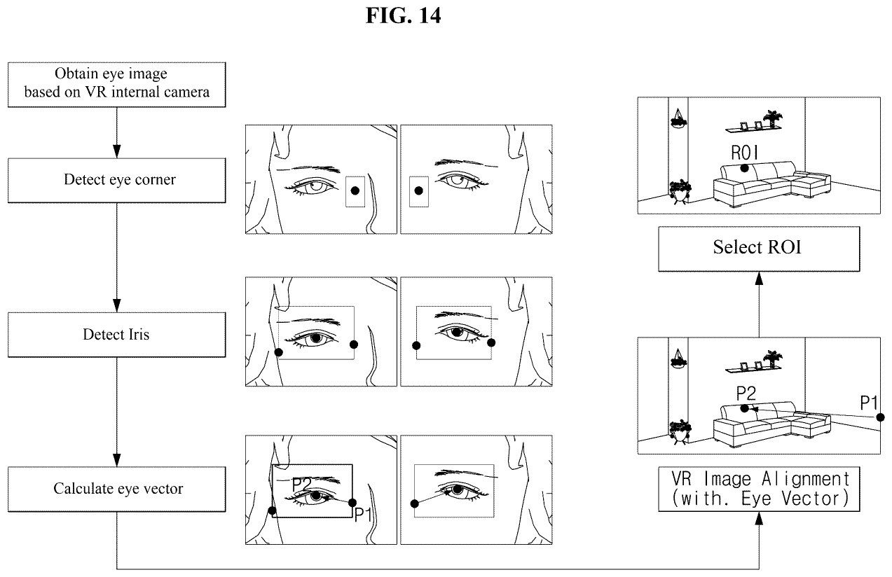

Referring to FIG. 6, when a VR input image is a 2D image type, a personal immersive display apparatus according to an embodiment of the present disclosure can be driven in a first power saving mode, and when the VR input image is a mixed or combination image type of 2D and 3D images, the personal immersive display apparatus according to an embodiment of the present disclosure can be driven in a second power saving mode. The first power saving mode will be described in detail with reference to FIGS. 8 to 12B. The second power saving mode will be described in detail with reference to FIGS. 13 to 17B.

The first power saving mode and the second power saving mode can use one of a left-eye display and a right-eye display as a power saving display and can use the other display (i.e., the other of the left-eye display and the right-eye display) as a non-power saving display, and thus, can be the same. In an overlap image region of the power saving display, a maximum luminance of an overlap image can represent a luminance reduction rate which is set to be lower than 100%. On the other hand, in an overlap image region of the non-power saving display, a maximum luminance of an overlap image can represent 100%. A user may not recognize an overlap image of a power saving display which is relatively low in luminance and can recognize an overlap image of a non-power saving display which is relatively high in luminance.

Referring to FIG. 7, a personal immersive display apparatus according to an embodiment of the present disclosure can compare a left-eye image L-IMG and a right-eye image R-IMG which are to be displayed on an overlap image region and when the left-eye image L-IMG are the same as the right-eye image R-IMG, the personal immersive display apparatus can determine a VR input image as a 2D image type. On the other hand, when the left-eye image L-IMG differs from the right-eye image R-IMG, the personal immersive display apparatus can determine the VR input image as the combination image type of 2D and 3D images.

FIG. 8 is a diagram illustrating a method of implementing a first power saving mode corresponding to a 2D image type.

Referring to FIG. 8, a personal immersive display apparatus according to an embodiment of the present disclosure can set one of left-eye and right-eye displays DIS-L and DIS-R to a power saving display and can set the other display to a non-power saving display.

In the power saving display, a maximum luminance of an overlap 2D image to be displayed on an overlap image region OA can represent a luminance reduction rate which is set to be lower than 100%. On the other hand, in the non-power saving display, the maximum luminance of the overlap 2D image to be displayed on the overlap image region OA can represent 100%.

The personal immersive display apparatus according to an embodiment of the present disclosure can decrease the maximum luminance of the overlap 2D image by a predetermined luminance reduction rate with respect to the overlap image region OA of the power saving display and can maintain 100% of a maximum luminance of a non-overlap 2D image with respect to a non-overlap image region NOA of the power saving display. The overlap image region OA can include a boundary processing region SA contacting the non-overlap image region NOA. The personal immersive display apparatus can gradually increase the maximum luminance of the overlap 2D image up to 100% from the luminance reduction rate with respect to the boundary processing region SA of the power saving display, and thus, can smooth a luminance variation between the overlap image region OA and the non-overlap image region NOA, thereby removing a possibility that visual inconvenience occurs.

The personal immersive display apparatus according to an embodiment of the present disclosure can multiply a gray level variation rate R(x) and input image data IN(x,y) which is to be supplied to the overlap image region OA of the power saving display and can thus output power-saving image data OUT(x,y). The maximum luminance of the overlap image region OA can decrease by the predetermined luminance reduction rate, based on the power-saving image data OUT(x,y).

The personal immersive display apparatus according to an embodiment of the present disclosure can multiply the gray level variation rate R(x) and the input image data IN(x,y) which is to be supplied to the boundary processing region SA of the power saving display and can thus output the power-saving image data OUT(x,y). The maximum luminance of the boundary processing region SA can gradually increase up to 100% from the luminance reduction rate, based on the power-saving image data OUT(x,y).

The personal immersive display apparatus according to an embodiment of the present disclosure may not multiply the gray level variation rate R(x) and the input image data IN(x,y) which is to be supplied to the non-overlap image region NOA of the power saving display and can bypass the input image data IN(x,y). Accordingly, the maximum luminance of the non-overlap image region NOA can intactly represent original 100%.

Furthermore, the personal immersive display apparatus according to an embodiment of the present disclosure may not multiply the gray level variation rate R(x) and the input image data IN(x,y) which is to be supplied to the overlap image region OA and the non-overlap image region NOA of the non-power saving display and can bypass and output the input image data IN(x,y). Accordingly, the maximum luminance of each of the overlap image region OA and the non-overlap image region NOA of the non-power saving display can intactly represent original 100%.

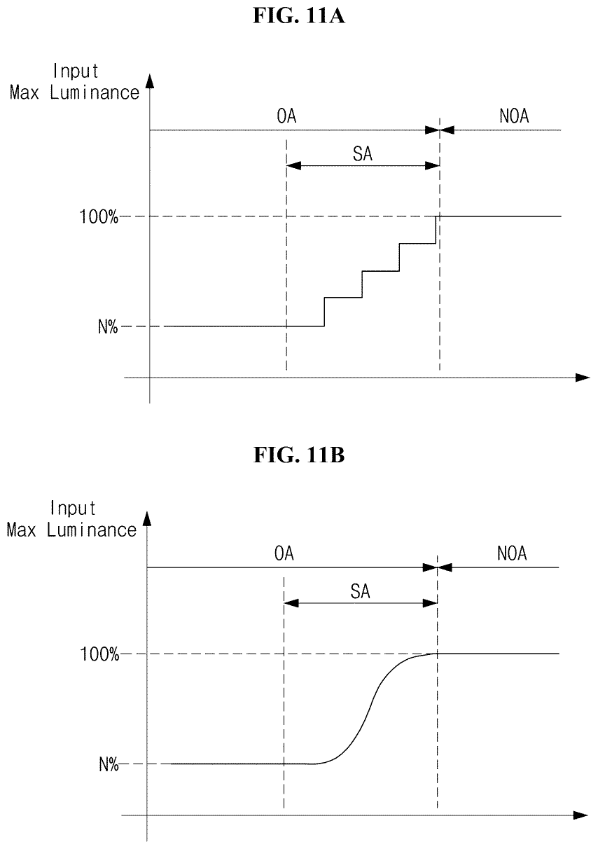

FIG. 9 is a diagram illustrating an example which implements a left-eye display as a power saving display and implements a right-eye display as a non-power saving display, in a first power saving mode.

Referring to FIG. 9, in a left-eye display DIS-L which is the power saving display, a left-eye non-overlap 2D image L-IMG having a maximum luminance of 100% can be displayed on a non-overlap image region NOA1, and a left-eye overlap 2D image L-IMG having a maximum luminance of N % (where N can be a natural number of less than 100) can be displayed on an overlap image region OA except a boundary processing region SA. A left-eye overlap 2D image L-IMG having a maximum luminance which decreases gradually in a diagonal shape up to N % from 100% can be displayed on the boundary processing region SA.

Referring to FIG. 9, in a right-eye display DIS-R which is a non-power saving display, a right-eye overlap 2D image R-IMG having a maximum luminance of 100% can be displayed on the overlap image region OA, and a right-eye non-overlap 2D image R-IMG having a maximum luminance of 100% can be displayed on a non-overlap image region NOA2.

FIG. 10 is a diagram illustrating an example which implements a right-eye display as a power saving display and implements a left-eye display as a non-power saving display, in a first power saving mode.

Referring to FIG. 10, in a right-eye display DIS-R which is a power saving display, a right-eye non-overlap 2D image R-IMG having a maximum luminance of 100% can be displayed on a non-overlap image region NOA2, and a right-eye overlap 2D image R-IMG having a maximum luminance of N % can be displayed on an overlap image region OA except a boundary processing region SA. A right-eye overlap 2D image R-IMG having a maximum luminance which decreases gradually in a diagonal shape up to N % from 100% can be displayed on the boundary processing region SA.

In a left-eye display DIS-L which is a non-power saving display, a left-eye overlap 2D image L-IMG having a maximum luminance of 100% can be displayed on the overlap image region OA, and a left-eye non-overlap 2D image L-IMG having a maximum luminance of 100% can be displayed on the non-overlap image region NOA2.

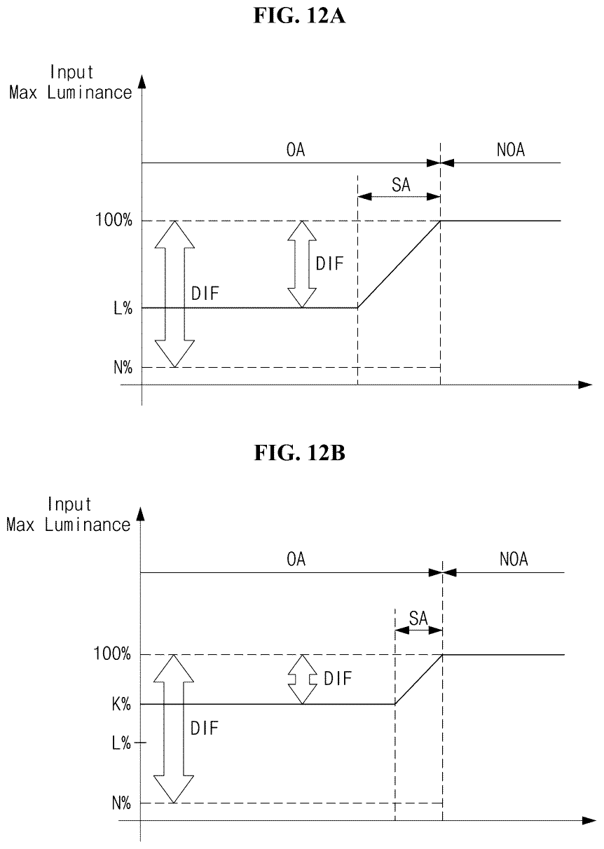

FIGS. 11A and 11B are diagrams illustrating a luminance variation form in a boundary processing region, contacting a nonoverlap image region, of an overlap image region.

Referring to FIG. 11A, a maximum luminance of an overlap 2D image displayed on a boundary processing region SA can vary gradually in a step shape up to 100% from N %, and thus, a luminance variation between an overlap image region OA and a non-overlap image region NOA can be smoothly performed, thereby removing a possibility that visual inconvenience occurs.

Referring to FIG. 11B, a maximum luminance of an overlap 2D image displayed on a boundary processing region SA can vary gradually in an S-shape up to 100% from N %, and thus, a luminance variation between an overlap image region OA and a non-overlap image region NOA can be smoothly performed, thereby removing a possibility that visual inconvenience occurs.

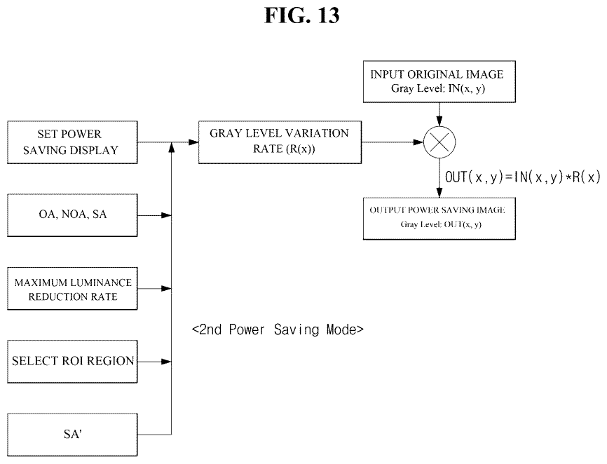

FIGS. 12A and 12B are diagrams illustrating an example where a width of a boundary processing region is differently set based on a luminance difference between an overlap image region and a nonoverlap image region.

In a personal immersive display apparatus according to an embodiment of the present disclosure, a width of a boundary processing region SA can be set to be proportional to a maximum luminance difference between 100% and a luminance reduction rate, in order to obtain a smoothing processing effect and a low power effect. When the maximum luminance difference is large, a width of the boundary processing region SA for smoothing processing can be wide, and when the maximum luminance difference is small, a width of the boundary processing region SA for smoothing processing can be narrow.

For example, as in FIG. 12A, when a luminance reduction rate is re-set to L % (where L can be a natural number of more than N and less than 100) from N %, a width of the boundary processing region SA can decrease more in L % than in N %.

Moreover, as in FIG. 12B, when a luminance reduction rate is re-set to K % (where K can be a natural number of more than N and L and less than 100) from N %, a width of the boundary processing region SA can decrease more in K % than in N % and L %.

FIG. 13 is a diagram illustrating a method of implementing a second power saving mode corresponding to a combination image type of 2D and 3D images.

Referring to FIG. 13, a personal immersive display apparatus according to an embodiment of the present disclosure can set one of left-eye and right-eye displays DIS-L and DIS-R to a power saving display and can set the other display to a non-power saving display.

In the power saving display, a maximum luminance of an overlap 2D image to be displayed on an overlap image region OA can represent a luminance reduction rate which is set to be lower than 100%. On the other hand, in the non-power saving display, the maximum luminance of the overlap 2D image to be displayed on the overlap image region OA can represent 100%.

The personal immersive display apparatus according to an embodiment of the present disclosure can decrease the maximum luminance of the overlap 2D image by a predetermined luminance reduction rate with respect to the overlap image region OA of the power saving display and can maintain 100% of a maximum luminance of a non-overlap 2D image with respect to a non-overlap image region NOA of the power saving display. The overlap image region OA can include a boundary processing region SA contacting the non-overlap image region NOA. The personal immersive display apparatus can gradually increase the maximum luminance of the overlap 2D image up to 100% from the luminance reduction rate with respect to the boundary processing region SA of the power saving display, and thus, can smooth a luminance variation between the overlap image region OA and the non-overlap image region NOA, thereby removing a possibility that visual inconvenience occurs.

The overlap image region OA of the power saving display can further include a 3D region which displays an overlap 3D image, in addition to a 2D region which displays an overlap 2D image. In this case, the 2D region can be a background region, and the 3D region can be a region of interest (ROI) based on eye tracking on the overlap 3D image. The personal immersive display apparatus can maintain 100% of a maximum luminance of the overlap 3D image with respect to a 3D region of the power saving display, and thus, can prevent 3D crosstalk from occurring due to a maximum luminance variation in the 3D region.

In the overlap image region OA of the power saving display, a 2D region can include an auxiliary boundary processing region SA′ contacting the 3D region. The personal immersive display apparatus can gradually increase a maximum luminance of the overlap 2D image up to 100% from the luminance reduction rate with respect to the auxiliary boundary processing region SA′ of the power saving display, and thus, can smooth a luminance variation between the 2D region and the 3D region, thereby removing a possibility that visual inconvenience occurs.

The personal immersive display apparatus according to an embodiment of the present disclosure can multiply a gray level variation rate R(x) by input image data IN(x,y) which is to be supplied to the 2D region of the overlap image region OA of the power saving display and can thus output power-saving image data OUT(x,y). The maximum luminance of the 2D region included in the overlap image region OA can decrease by the predetermined luminance reduction rate, based on the power-saving image data OUT(x,y).

The personal immersive display apparatus according to an embodiment of the present disclosure can multiply the gray level variation rate R(x) and the input image data IN(x,y) which is to be supplied to the boundary processing region SA and the auxiliary boundary processing region SA′ of the power saving display and can thus output the power-saving image data OUT(x,y). The maximum luminance of the boundary processing region SA can gradually increase up to 100% from the luminance reduction rate, based on the power-saving image data OUT(x,y).

The personal immersive display apparatus according to an embodiment of the present disclosure may not multiply the gray level variation rate R(x) and the input image data IN(x,y) which is to be supplied to the 3D region of the overlap image region OA of the power saving display and can bypass the input image data IN(x,y). Accordingly, the maximum luminance of the 3D region can intactly represent original 100%, thereby securing the quality of a 3D image.

The personal immersive display apparatus according to an embodiment of the present disclosure may not multiply the gray level variation rate R(x) and the input image data IN(x,y) which is to be supplied to the non-overlap image region NOA of the power saving display and can bypass the input image data IN(x,y). Accordingly, the maximum luminance of the non-overlap image region NOA can intactly represent original 100%.

Furthermore, the personal immersive display apparatus according to an embodiment of the present disclosure may not multiply the gray level variation rate R(x) and the input image data IN(x,y) which is to be supplied to the overlap image region OA and the non-overlap image region NOA of the non-power saving display and can bypass and output the input image data IN(x,y). Accordingly, the maximum luminance of each of the overlap image region OA and the non-overlap image region NOA of the non-power saving display can intactly represent original 100%.

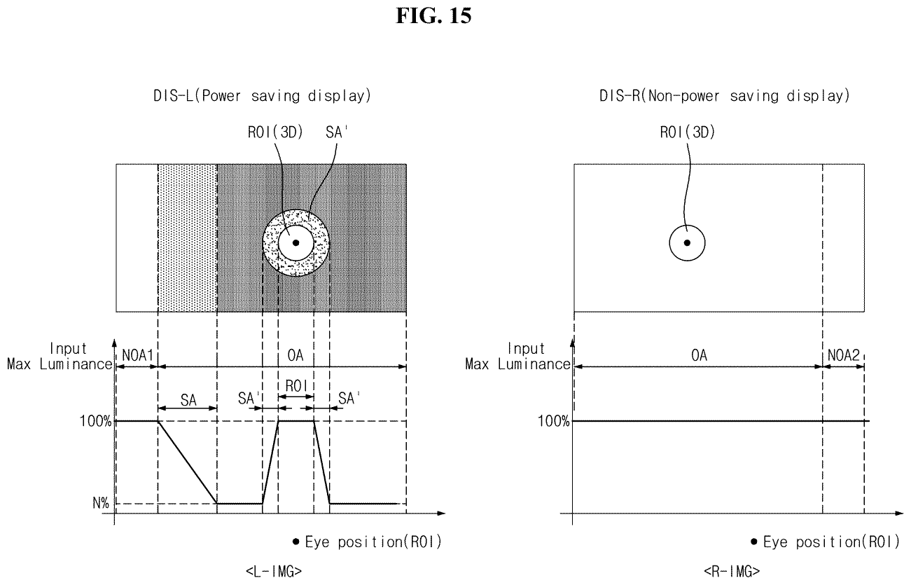

FIG. 14 is a diagram illustrating a method of selecting an ROI based on eye tracking.

Referring to FIG. 14, a personal immersive display apparatus according to an embodiment of the present disclosure can obtain binocular imaging information about a user through a camera equipped therein.

The personal immersive display apparatus can detect both-eye corner points and both-eye irises, based on the binocular imaging information.

The personal immersive display apparatus can calculate a left-eye vector facing a left-eye iris P2 at a left-eye corner point P1. Likewise, the personal immersive display apparatus can calculate a right-eye vector facing a right-eye iris at a right-eye corner point.

The personal immersive display apparatus can align the left-eye vector in a left-eye image to select an ROI of the left-eye image and can align the right-eye vector in a right-eye image to select an ROI of the right-eye image.

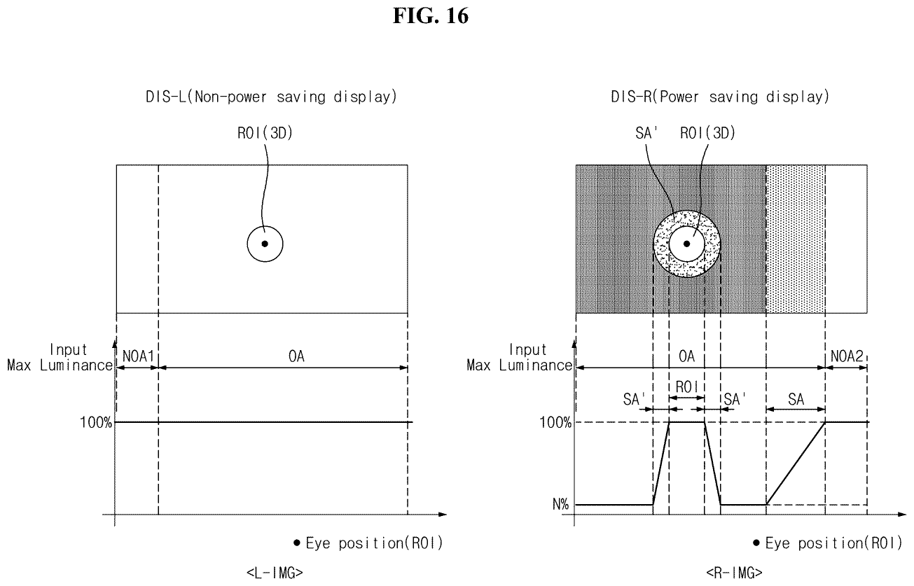

FIG. 15 is a diagram illustrating an example which implements a left-eye display as a power saving display and implements a right-eye display as a non-power saving display, in a second power saving mode.

Referring to FIG. 15, in a left-eye display DIS-L which is a power saving display, a left-eye non-overlap 2D image L-IMG having a maximum luminance of 100% can be displayed on a non-overlap image region NOA1, and a left-eye overlap 2D image L-IMG having a maximum luminance of N % (where N can be a natural number of less than 100) can be displayed on an overlap image region OA except a boundary processing region SA and an auxiliary boundary processing region SA′. A left-eye overlap 2D image L-IMG having a maximum luminance which decreases gradually in a diagonal shape up to N % from 100% can be displayed on the boundary processing region SA and the auxiliary boundary processing region SA′. A left-eye overlap 3D image L-IMG having a maximum luminance of 100% can be displayed on a 3D overlap image region ROI.

In a right-eye display DIS-R which is a non-power saving display, a right-eye overlap 2D image R-IMG and a right-eye overlap 3D image R-IMG having a maximum luminance of 100% can be displayed on the overlap image region OA, and a right-eye non-overlap 2D image R-IMG having a maximum luminance of 100% can be displayed on a non-overlap image region NOA2.

FIG. 16 is a diagram illustrating an example which implements a right-eye display as a power saving display and implements a left-eye display as a non-power saving display, in a second power saving mode.

Referring to FIG. 16, in a right-eye display DIS-R which is a power saving display, a right-eye non-overlap 2D image R-IMG having a maximum luminance of 100% can be displayed on a non-overlap image region NOA2, and a right-eye overlap 2D image R-IMG having a maximum luminance of N % can be displayed on an overlap image region OA except a boundary processing region SA and an auxiliary boundary processing region SA′. A right-eye overlap 2D image R-IMG having a maximum luminance which decreases gradually in a diagonal shape up to N % from 100% can be displayed on the boundary processing region SA and the auxiliary boundary processing region SA′. A right-eye overlap 3D image R-IMG having a maximum luminance of 100% can be displayed on a 3D overlap image region ROI.

In a left-eye display DIS-L which is a non-power saving display, a left-eye overlap 2D image L-IMG and a left-eye overlap 3D image L-IMG having a maximum luminance of 100% can be displayed on the overlap image region OA, and a left-eye non-overlap 2D image L-IMG having a maximum luminance of 100% can be displayed on the non-overlap image region NOA2.

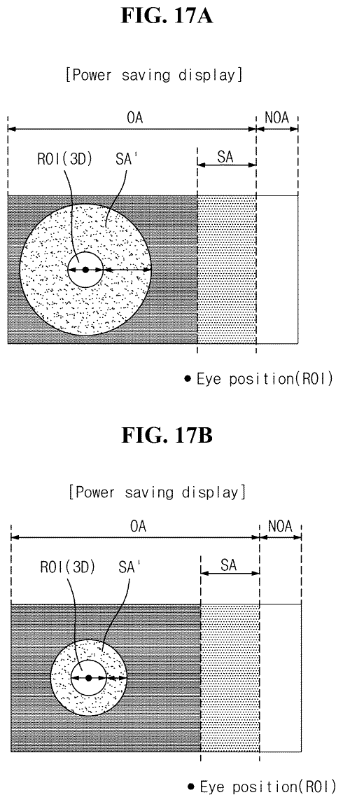

FIGS. 17A and 17B are diagrams illustrating an example where a width of an auxiliary boundary processing region is differently set based on a moving speed of an ROI.

In a personal immersive display apparatus according to an embodiment of the present disclosure, a width of an auxiliary boundary processing region SA′ can be set to be proportional to a moving speed of an ROI, in order to obtain all of a smoothing processing effect and a low power effect.

For example, as illustrated in FIG. 17A, in an eye tracking result based on a camera, when an ROI quickly moves, a width of the auxiliary boundary processing region SA′ can be set to be wide. On the other hand, as illustrated in FIG. 17B, in an eye tracking result based on a camera, when an ROI slowly moves, a width of the auxiliary boundary processing region SA′ can be set to be narrow.

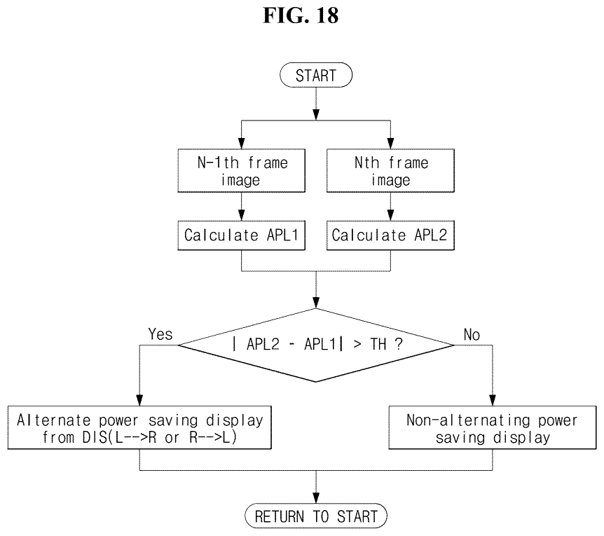

FIG. 18 is a diagram illustrating a method of replacing a power saving display.

Referring to FIG. 18, the power saving display can be changed from a left-eye display to a right-eye display or can be changed to be opposite thereto, at a period of a certain time.

The replacement of the power saving display can be performed during a scene change period where an average picture level (APL) difference “APL2-APL1” between continuous frames is greater than a predetermined threshold value TH. Accordingly, a problem where the visibility of a user is reduced when replacing the power saving display can be prevented.

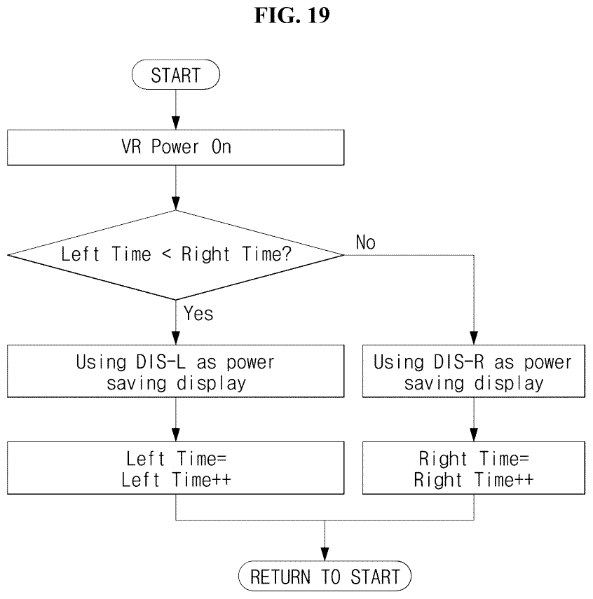

FIG. 19 is a diagram illustrating another method of replacing a power saving display.

Referring to FIG. 19, the power saving display can be changed from a left-eye display to a right-eye display or can be changed from the right-eye display to the left-eye display, with respect to a use accumulation time.

When a system power is turned on, a display, where a time taken in using as the power saving display is relatively shorter, of the left-eye and right-eye displays can be set to be the power saving display.

To this end, first accumulation time information about the left-eye display being used as the power saving display and second accumulation time information about the right-eye display being used as the power saving display can be individually stored in an internal memory.

When the system power is turned on, the first accumulation time information and the second accumulation time information can be downloaded.

As described above, the personal immersive display apparatus according to the embodiments of the present disclosure can reduce a maximum luminance of one of the left-eye display and the right-eye display and can be used as the power saving display, thereby effectively reducing power consumption while maintaining image quality.

The present disclosure can realize the following effects.

The personal immersive display apparatus according to the embodiments of the present disclosure can reduce the maximum luminance of one of a left-eye display and a right-eye display and can be used as a power saving display, thereby effectively reducing power consumption while maintaining image quality.

The effects according to the present disclosure are not limited to the above examples, and other various effects can be included in the disclosure.

While the present disclosure has been particularly shown and described with reference to example embodiments thereof, it will be understood by those of ordinary skill in the art that various changes in form and details can be made therein without departing from the spirit and scope of the present disclosure as defined by the following claims.

What is claimed is:

1. A personal immersive display apparatus comprising:
a left-eye display configured to display a left-eye image; and
a right-eye display configured to display a right-eye image,
wherein an entire image simultaneously implemented on the left-eye and right-eye displays includes an overlap image region where the left-eye image and the right-eye image overlap each other and a non-overlap image region of the left-eye image or the right-eye image disposed at one side of the overlap image region,
wherein the overlap image region comprises a two-dimensional (2D) region configured to display a left-eye overlap 2D image and a right-eye overlap 2D image, and
wherein a maximum luminance of one of the left-eye overlap 2D image and the right-eye overlap 2D image is lower than a maximum luminance of the other of the left-eye overlap 2D image and the right-eye overlap 2D image overlap 2D image.

2. The personal immersive display apparatus of claim 1, wherein the maximum luminance of one of the left-eye overlap 2D image and the right-eye overlap 2D image represents a luminance reduction rate which is set to be lower than 100%, and
wherein the maximum luminance of the other of the left-eye overlap 2D image and the right-eye overlap 2D image represents 100%.

3. The personal immersive display apparatus of claim 2, wherein the one of the left-eye display and the right-eye display is a power saving display where a maximum luminance of an overlap 2D image represents the luminance reduction rate, and
the other of the left-eye display and the right-eye display is a non-power saving display where the maximum luminance of the overlap 2D image represents 100%.

4. The personal immersive display apparatus of claim 3, wherein the overlap image region of the power saving display comprises a boundary processing region contacting the non-overlap image region,
wherein a maximum luminance of a non-overlap 2D image displayed on the non-overlap image region represents 100%.

5. The personal immersive display apparatus of claim 4, wherein a maximum luminance of an overlap 2D image displayed on the boundary processing region varies from the luminance reduction rate to 100%.

6. The personal immersive display apparatus of claim 5, wherein the maximum luminance of the overlap 2D image displayed on the boundary processing region varies in one shape of a diagonal shape, a step shape, and an S-shape up to 100% from the luminance reduction rate.

7. The personal immersive display apparatus of claim 5, wherein a width of the boundary processing region is set to be proportional to a maximum luminance difference between 100% and the luminance reduction rate.

8. The personal immersive display apparatus of claim 3, wherein the overlap image region further comprises a three-dimensional (3D) region configured to display a left-eye overlap 3D image and a right-eye overlap 3D image,
wherein the 3D region is a region of interest (ROI) based on eye tracking on the left-eye overlap 3D image and the right-eye overlap 3D image, and
wherein a maximum luminance of each of the left-eye overlap 3D image and the right-eye overlap 3D image is 100%.

9. The personal immersive display apparatus of claim 8, wherein the 2D region further comprises an auxiliary boundary processing region contacting the 3D region, in the overlap image region of the power saving display.

10. The personal immersive display apparatus of claim 9, wherein a maximum luminance of an overlap 2D image displayed on the auxiliary boundary processing region varies from the luminance reduction rate to 100%.

11. The personal immersive display apparatus of claim 9, wherein a width of the auxiliary boundary processing region is set to be proportional to a moving speed of the ROI.

12. The personal immersive display apparatus of claim 3, wherein, during a scene change period where an average picture level difference between continuous frames is greater than a predetermined threshold value, the power saving display is changed from the left-eye display to the right-eye display, or is changed from the right-eye display to the left-eye display.

13. The personal immersive display apparatus of claim 3, wherein, when a system power is turned on, a display, where a time taken in using the power saving display is shorter, of the left-eye display and the right-eye display is set to be the power saving display.

14. The personal immersive display apparatus of claim 13, wherein first accumulation time information about the left-eye display being used as the power saving display and second accumulation time information about the right-eye display being used as the power saving display is individually stored in an internal memory, and
wherein when the system power is turned on, the first accumulation time information and the second accumulation time information are downloaded.

15. The personal immersive display apparatus of claim 1, wherein the non-overlap image region is of both the left-eye image and the right-eye image disposed at opposite sides of the overlap image region.

16. The personal immersive display apparatus of claim 1, wherein the personal immersive display apparatus is a virtual reality display device.

17. A driving method of a personal immersive display apparatus, the driving method comprising:
displaying a left-eye image on a left-eye display; and
displaying a right-eye image on a right-eye display,
wherein an entire image simultaneously implemented on the left-eye and right-eye displays includes an overlap image region where the left-eye image and the right-eye image overlap each other and a non-overlap image region of the left-eye image or the right-eye image disposed at one side of the overlap image region,
wherein the overlap image region comprises a two-dimensional (2D) region configured to display a left-eye overlap 2D image and a right-eye overlap 2D image, and
wherein a maximum luminance of one of the left-eye overlap 2D image and the right-eye overlap 2D image is lower than a maximum luminance of the other of the left-eye overlap 2D image and the right-eye overlap 2D image.
